(19) United States
(12) Patent Application Publication
(10) Pub. No.: US 2007/0256899 A1
(43) Pub. Date: Nov. 8, 2007

(54) Method For Mounting A Car Drive Machine, Especially For Elevators Without Any Machine Room And Elevator Obtained

(76) Inventors: Hughes Fanielle, Orleans (FR); Franck Pouget, Gien (FR); Patrice Letellier, Andresy (FR); Denis Gauthier, Saint Cyr en Vel (FR)

Correspondence Address: Lisa A. Bongiovi;Otis Elevator Company, 10 Farm Springs, Farmington, CT, 06032, US

(21) Appl. No.: 10/573,504

(22) PCT Filed: Sep. 29, 2003
(86) PCT No.: PCT/IB03/04304

§ 371 Date: Mar. 20, 2007

(51) Int. Cl. B66B 7/00

(52) U.S. Cl. 187/408

(57) ABSTRACT

The invention concern a method for mounting a car drive machine (9), especially for elevators having no machine room, the drive machine (9) being to be affixed to a structure in the hoistway, characterized in that it successively consists of positioning said drive machine (9) on a support (23) positioned so as to be suitably on the top of the elevator car (7) and being able to move transversally, to lift the elevator car (7) until the machine is slightly above said structure, to move the support (23) with the machine (9) transversally and outwardly so as to position the machine (9) immediately above its fixing position, to lower the car (7) so as to place and fix the machine (9) on said structure, and to bring said support (23) back transversally so as to free it from the machine (9).

The invention concerns a method for mounting a car drive machine, especially for elevators having no machine room, and the elevator obtained.

The mounting of the drive machine of the car in elevators having no machine room is currently effected by lifting the machine in the hoistway by a winch type elevator device, the machine being lifted suspended to the cable. Nevertheless, this mounting is subject to a swaying movement of the suspended load with a risk of hooking of the elements of the hoistway, or of impact on the wall of the hoistway and of suspended load, which may damage the hoistway and the machine.

The same risk is in the method disclosed by EP 1 245 522, by which the drive unit must be raised from floor to an intermediate top seat in the elevator shaft.

The invention seeks to overcome these drawbacks and to this effect offers a method for mounting a car drive machine, especially for elevators having no machine room, the drive machine being to be affixed to a structure in the hoistway, characterised in that it successively consists of positioning said drive machine on a support positioned so as to be suitably on the top of the elevator car and being able to move transversally, to lift the elevator car until the machine is slightly above said structure, to move the support with the machine transversally and outwardly so as to position the machine immediately above its fixing position, to lower the car so as to place and fix the machine on said structure, and to bring said support back transversally so as to free it from the machine.

More particularly the invention offers a method for mounting the car drive machine, especially for elevators having no machine room, the drive machine appearing in the form of a block with longitudinal shape intended to be fixed to the top of two counter-weight guide rails and a car guide rail on one side of the elevator hoistway, said method being characterised in that it successively consists of positioning said drive machine on a flat surface positioned properly on the top part of the elevator car and being able to move transversally, of lifting the elevator car by means of an auxiliary elevator device up to bring the machine slightly above the top of said guide rails, of moving the flat support with the machine transversally and outwardly so as to position the machine immediately above its fixing position on said rails, of lowering the car so as to place and fix the machine on the rails, of transversally bringing back inwardly the flat support so as to free it from the usage.

Said flat support is advantageously a table or frame provided with a plate possibly pierced at the passage point of the elements of fixation of the machine to the rails, said plate being mounted sliding transversally on the table or frame.

Said table or frame is secured to a rigid element of the car, for example on the upper crosspiece of the notch of the car.

Said auxiliary elevator device is a man-lift winch whose cable is fixed by one end to the car and by the other end to the ceiling of the hoistway or which is fixed to the car with one end of the cable fixed to the ceiling of the hoistway.

The machine is able to be fixed directly to the rails by means of brackets, but is preferably secured to a support frame mounted fixed to the top of the rails. The machine is secured to the support frame by means of screws directly in attack in its body.

The machine has a block shape and is constituted by a median cylindrical pulley block to which the motor is attached at one extremity and the braking device is attached on the other extremity, this machine being positioned on said sliding plate via its pulley block placed on the plate, the respective motor and brake fastening feet laterally extending beyond with a small amount of play of the edge of the plate and the rear edge of the pulley block resting against a rear stop fold of the plate so that the machine is prepositioned on the latter.

The fixing screws for fixing the machine to said support frame are in attack on the respective motor and brake fastening feet so that when the machine is placed or fixed to the frame, the plate can be removed via a simple movement of the latter inside the residual space existing between the pulley block and said motor and brake fastening feet.

The invention also concerns a machine-installation table for implementing the above defined method and an elevator obtained by the above-defined method of the invention.

The invention is illustrated hereafter with the aid of an example of embodiment and with reference to the accompanying drawings on which:

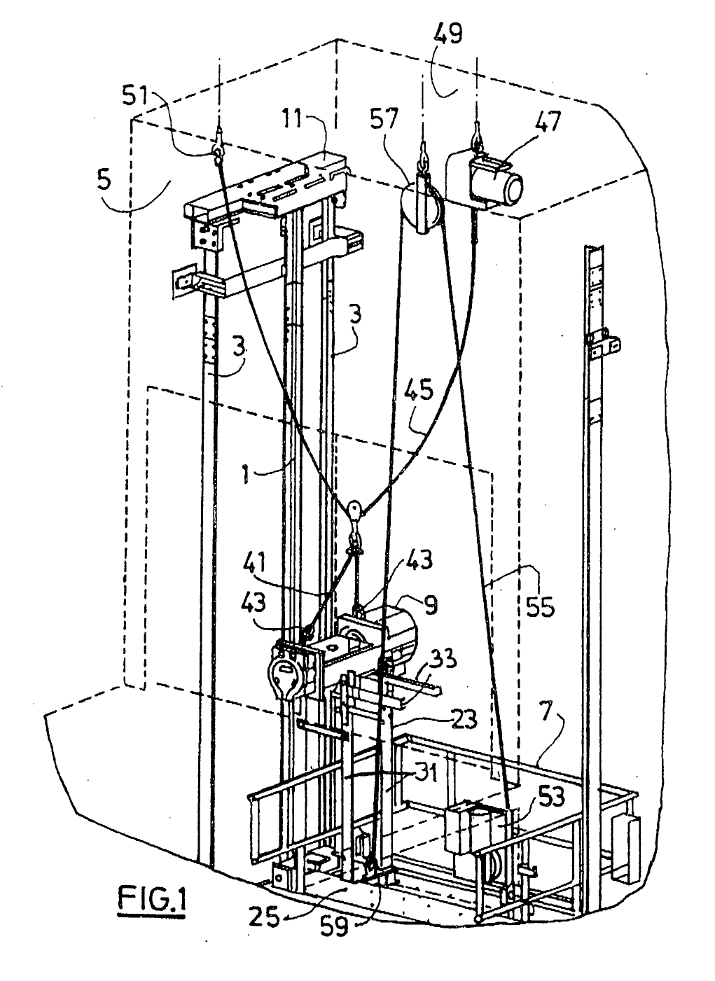

FIG. 1 is a perspective view showing the placing of the drive machine of the car on a support table of the car inside an elevator hoistway,

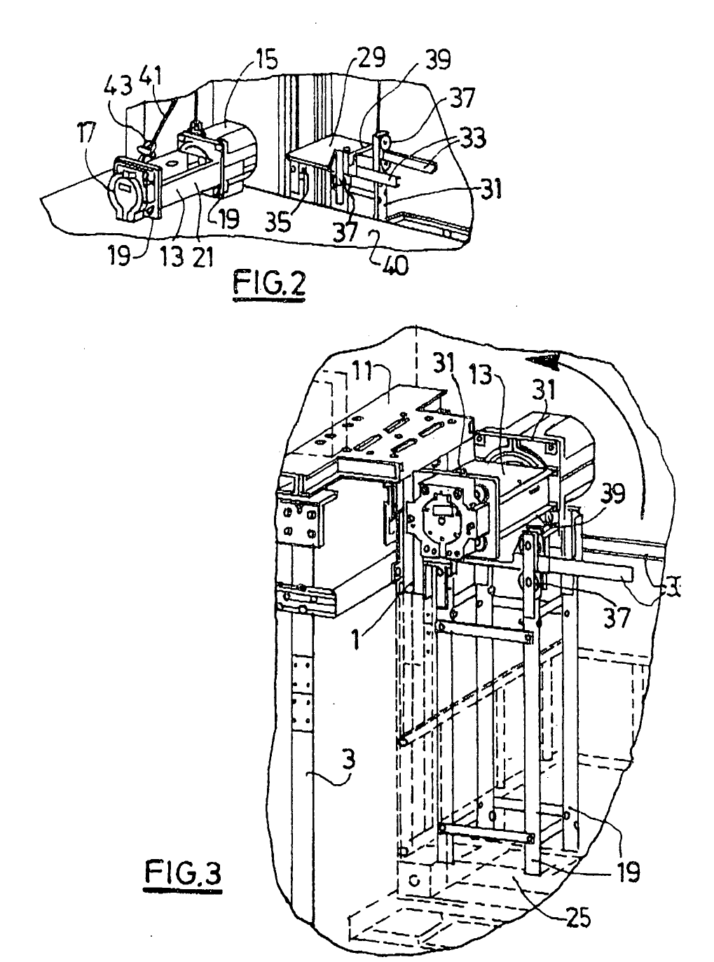

FIG. 2 is a perspective view of the support table receiving the car drive machine, and

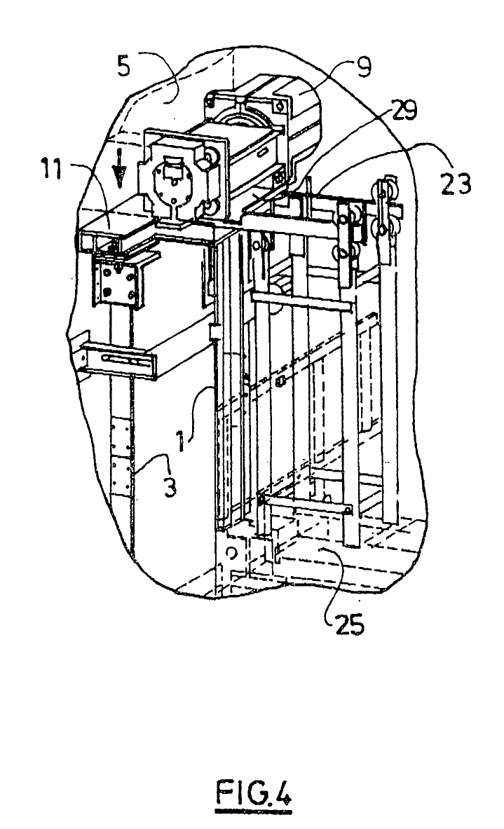

FIGS. 3 and 4 show the successive mounting of the drive machine on its support frame.

With reference to the drawings and more particularly to FIG. 1, the method of the invention is implemented in an elevator of the type having no machine room and flat traction belts, after the car guide rails 1 and counterweight ones 3 are fixed in the elevator hoistway 5 and the car itself 7 and the counterweight (not shown) are positioned on their respective rails. This involves mounting the drive machine 9 of the car on a support frame 11 fixed at the top front median portion to a car guide rail 1 and laterally and in the rear to counterweight guides 3 on a same side of the elevator hoistway 5.

The machine (FIG. 2) is constituted by a longitudinal shaping block 13 provided with a median cylindrical pulley (not shown) able to comprise several belt receiving throats, a motor 15 at one extremity and a braking device 17 at the other extremity. The motor 15 and the brake 17 are fixed to the median pulley by fastening feet 19, respectively the fastening foot of the motor and the fastening foot of the braking device. These feet 19 are symmetrical with respect to one another relatively to a vertical median plane of the pulley block 13.

The both, of which only the upper portion is shown, is equipped with a machine support table 23 of the machine, mounted and able to be dismantled on the upper crosspiece 25 of its notch. This support table 23 is made up of a frame and an upper horizontal plate 29 mounted sliding transversally on the frame. The frame comprises several vertical feet 31 fixed to the notch crosspiece 25 and two horizontal parallel beams 33 orientated approximately perpendicular to the side of the hoistway near the support frame of the machine. The external extremity of the beams 33 is close to the vertical plane passing through the internal extremity (front) of the support frame 11 of the machine.

The sliding plate 29 is mounted rolling on said beams 33 by means of front lower rollers 35, and rollers and rear rollers 37. This plate 29 has a rectangular shape with dimensions slightly smaller than those of the median pulley block 13 so as to simply receive it placed as shown on FIG. 1, a short distance away or slightly stopped against an upper projection rear fold 39 of the plate.

The machine is thus positioned precisely on the plate and the same applies to the support table on the car so as to allow its prepositioning at a certain height on the machine support frame after the transversal sliding of the plate to a predetermined end of travel position.

The method for mounting the machine is described hereafter.

Initially, the machine 9 is slung from a building storey landing 40 (FIG. 2) with the aid of a short cable 41 connected to two upper ears 43 respectively integral with the motor fastening foot and the fastening foot of the brake. The cable is borne by means of a ring and a return pulley on the cable 45 of an upper winch 47 fixed to the hoistway ceiling 49, the extremity 51 of the cable being fixed to the hoistway ceiling. The machine is lifted up by means of the remote-controlled winch 47 and then placed (FIG. 1) on the plate 29 of the table via its pulley block 13 being prepositioned to stop on the rear fold 39 of the plate and transversally via its feet 19 projecting laterally with a small amount of play beyond the plate. The machine then rests on the car and can be lifted up by the device of the car with the aid of a person lifting winch 53 with a capacity of more than 1000 kg fixed temporarily onto the top of the car 55 and whose cable 55 is winched by means of a return pulley 57 to the ceiling of the hoistway 49 and the extremity 59 is connected to the car upper crosspiece 25.

Thus, the car is lifted up in its hoistway (FIG. 3) with its antifall safety device locked until the machine arrives slightly above the plane of the support frame 11, for example 10 cm above at the top of the hoistway.

The sliding plate 29 is then moved outwardly with the machine up to an end of travel position (FIG. 4) where the machine is found at the vertical point of its fixing location on the support frame 11. All there remains is to then slightly lower the car according to the arrow so as to place and fix the machine on its support more precisely by means of the motor and brake feet 19. The plate 29 sliding between the feet can then be moved inwardly into the residual space between the pulley block and the lower portion of the feet. Then it is possible to place the machine fixing screws which are directly screwed into holes provided under the frame in attack in complementary internal screw threads formed in the feet. All left now is to lower the car to its original position and to dismantle the support table of the machine for possibly another elevator mounting usage.

1. Method for mounting a car drive machine (9), especially for elevators having no machine room, the drive machine (9) being to be affixed to a structure in the hoistway, characterised in that it successively consists of positioning said drive machine (9) on a support (23) positioned so as to be suitably on the top of the elevator car (7) and being able to move transversally, to lift the elevator car (7) until the machine is slightly above said structure, to move the support (23) with the machine (9) transversally and outwardly so as to position the machine (9) immediately above its fixing position, to lower the car (7) so as to place and fix the machine (9) on said structure, and to bring said support (23) back transversally so as to free it from the machine (9).

2. Mounting method according to claim 1, the drive machine (9) appearing in the form of a longitudinal shaping block intended to be fixed to the top of two counterweight guide rails (3) and a car guide rail (1) on one side of the elevator hoistway (5), characterised in that it successively consists of positioning said drive machine (9) on a flat support (23) positioned so as to be suitably on the top of the elevator car (7) and being able to move transversally, to lift the elevator car (7) with the aid of an auxiliary lifting device (53) until the machine is slightly above the top of said guide rails (1, 3), to move the flat support (23) with the machine (9) transversally and outwardly so as to position the machine (9) immediately above its fixing position on said rails (1, 3), to lower the car (7) so as to place and fix the machine (9) on the rails (1, 3), to bring said flat support (23) back transversally so as to free it from the machine (9) and subsequently remove it from said car for a new usage.

3. Mounting method according to claim 2, characterised in that said flat support (23) is a table or frame provided with a plate (29) possibly pierced at the passage location of the fixing elements of the machine to the rails (1, 3), said plate (29) being mounted sliding transversally on the table or frame.

4. Mounting method according to claim 2 or 3, characterised in that said table or frame (23) is fixed to a rigid element of the car, for example to the upper crosspiece (25) of the car notch.

5. Mounting method according to one of the preceding claims 2-4, characterised in that said auxiliary lifting device (53) is a man-lift winching gear connected between the car and the hoistway ceiling.

6. Mounting method according to one of the preceding claims 2-5, characterised in that the machine (9) is fixed directly to the rails (1, 3) by means of fastening brackets.

7. Mounting method according to one of claims 2 to 5, characterised in that the machine (9) is fixed onto a support frame (11) fixed to the top of the rails (1, 3).

8. Mounting method according to claim 7, characterised in that the machine (9) is secured to the support frame (11) by means of screws directly in attack in its body.

9. Mounting method according to claim 7 or 8, characterised in that the machine (9) is of longitudinal shape and is made up of a median cylindrical pulley block (13), the motor (15) being attached to said pulley at one extremity and the brake (17) at the other extremity, this machine being positioned on said sliding plate (29) via its pulley block (13) placed on the plate (29), the respective motor and brake fastening feet (19) laterally projecting with a small amount of play beyond the edge of the plate (29) and the rear edge of the pulley block (13) resting against a rear stop fold (39) so that the machine (9) is prepositioned on the latter, the movement of the plate (29) being effected over a given length.

10. Mounting method according to one of claims 7 to 9, characterised in that the fixing screws of the machine (9) for fixing the latter to said support frame (11) are in attack on the respective brake and motor feet (19) so that when the machine (9) is placed or fixed on the frame (11), the plate (29) can be removed by merely moving the latter in the residual space between the pulley block (13) and said motor and brake fastening feet (19).

11. Machine-installation table to implement the method defined according to one of the preceding claims 3-10, characterised in that it includes a car-mounted frame (23) and a slidable machine-support surface (29).

12. Machine-installation table according to claim 11, characterised in that said car-mounted (23) frame fixed to a rigid element of the car, for example to the upper crosspiece (25) of the car notch.

13. Machine-installation table according to claim 11 or 12, characterised in that said slidable machine-support surface (29) is a table provided with a plate (29) possibly pierced at the passage location of the fixing elements of the machine to the rails (1, 3), said plate (29) being mounted sliding transversally on the table or frame.

14. Elevator obtained by implementing the method defined according to one of the preceding claims.
